(19) United States
(12) Patent Application Publication
(10) Pub. No.: US 2026/0358110 A1
(43) Pub. Date: Nov. 12, 2026

(54) A COORDINATE MOVEMENT MACHINE

(71) Applicant: CAPE PENINSULA UNIVERSITY OF TECHNOLOGY, Zonnebloem (ZA)

(72) Inventors: Ali RUGBANI, Zonnebloem (ZA); Bandile JAMA, Zonnebloem (ZA)

(21) Appl. No.: 19/129,190

(22) PCT Filed: Dec. 1, 2023
(86) PCT No.: PCT/IB2023/062116

§ 371 Date: May 12, 2025

(30) Foreign Application Priority Data
Dec. 2, 2022 (GB) 2218150.7

(51) Int. Cl. G01B 5/008; G01B 11/00

(52) U.S. Cl. CPC G01B 5/008; G01B 11/005

(57) ABSTRACT

A coordinate movement machine which includes a first member, a displacement measuring sensor, a reflective member and a displacement arrangement. The displacement measuring sensor is spaced from, and directed towards, the first member such that a functional line of the sensor is fixed on the first member. The reflective member is positioned in-between the sensor and the first member and whereby a reflective surface of the reflective member is angled perpendicular to the functional line of the sensor. The displacement arrangement is configured to move/displace the reflective member relative to the first member and the sensor along three axes which define a global coordinate system, whereby the axes are angled perpendicular to one another. The sensor is angled such that its functional line, which is fixed on the first member, is angled at an oblique angle relative to all three the axes.

### BACKGROUND OF THE INVENTION

Coordinate Measuring Machines (CMM) have successfully superseded traditional measuring techniques, resulting in reduced quality control operations, time, and effort [1]. They have displayed the potential for automated measurements, reverse engineering, and the ability to be integrated with computer manufacturing systems [1] [2]. These are mechanical systems used to perform three-dimensional (3D) inspections of physical components in manufacturing industries [3]. According to Nikam [3], the machine incorporates the basic concept of three coordinate axes to ensure precise movement in the x, y, and z directions. The measurement procedure of CMMs suggests the movement of measuring probes to determine the coordinates of points on the workpiece surface [1] [4]. Generally, the workpiece is fixed on a measuring table/stage, with a probe mounted on the metrology system to determine the discrete coordinates on the surface of the workpiece [1] [5]. When the probe encounters a workpiece it triggers, and the machine is activated to take samples from the measuring system provided on the moving axis. The samples are translated to the global coordinate system of the machine to determine the coordinates of the triggered location. When the full representative points are recorded, the data gets converted into the numerical model through a computer interface into physical measurement data. CMMs consist of four major functional components: the machine's main structure, the metrology system, the computer interface system, and the software to perform measurements [1]. These components can be designed and configured depending on the required metrology and automation systems.

The new developments towards miniaturization and the changes in technical specifications from foundries and aerospace, automotive, medical, semiconductor, electronic, and other manufacturing industries have driven the need for CMMs with less uncertainty [1] [6]. Therefore, to keep up with the miniaturization developments of parts from foundries and aerospace, automotive, medical, semiconductor, electronic, and other manufacturing industries, while observing the upcoming market demands, the industry is engaging in the development of fast 3-D CMM for measuring small products in an array with nanometre uncertainty [1] [6] [7] [8]. The complex geometrical features can include ear implants or hearing aids, gears of micro motors, small freeform lenses of mobile phones, injection systems for the automotive industry, or in the telecom sector for fibre optic or next-generation radio frequency technology components [9]. Such micro parts are often complex and large for optical microscopy techniques and their tiny structures are hardly accessible by means of conventional tactile coordinate measuring machines. [6] [10]. According to Cao et al and Yang et al [8], conventional measuring methods cannot meet these requirements because the measurement scales of conventional coordinate measuring machines (CMMs) are usually limited to several tens of millimetres or more, which is not suitable for measuring small parts of the order of sub-millimetres or even sub-micrometres. In addition, conventional CMMs lack good 3D measurement uncertainty levels and are often not supplied with the proper probing systems in many applications.

However, the cost of manufacturing CMMs has become a barrier towards the developments of the machine accuracy. The costly manufacturing process, together with the cost to buy components such as probe types, sensors and motors have been the contributing elements in elevating the total cost of the machine. This paper aims to improve the metrology system of the CMMs by introducing a novel single sensor Abbé free 3-D CMM machine.

There have been several new CMMs with the accuracy of tens of nanometers (called micro CMM or nano CMM) that have been developed with different metrology systems [6]. These designs include the Molecular Measuring Machine (M3) developed by the National Institute of Standards and Technology (NIST) [9]. M3 is a scanning probe microscopy (SPM) based metrology instrument that is designed to achieve sub-nanometer resolution with its probe and metrology system, over a macroscopic area of 50 mm by 50 mm. The goal is to achieve 1 nm combined uncertainty for point-to-point measurements within the working area. A low-cost micro-CMM was designed by Fan et al [13], with the measurement of meso-to-micro-scale parts. It is aimed at achieving 1 nm resolution and 30 nm repeatability within a measuring range of 25×25×10 mm³. So far, the Z-axis measurement can be controlled to within 15 nmrepeatability. Parts of the objectives have been achieved. Some problems due to current techniques will be addressed. Fan further developed a novel micro precision CMM that has force-balanced structure to yield high stiffness and conforms to the Abbé principle in 3D space [14]. The Designed CMM has a measurement volume of 25×25×10 mm in x, y and z directions respectively. Driven by the ultrasonic nanomotor and fed back by the hologram scale, each axis can achieve 1 nm resolution. The National Institute of Advanced Industrial Science and Technology (AIST) have developed a novel high-precision micro-CMM called M-CMM with a moving volume of 160 mm×160 mm×100 mm (x, y and z), aiming to achieve a measuring uncertainty of 50-nm measurement uncertainty with a measuring volume of 30 mm×30 mm×10 mm (x, y and z) [8]. Ruijl and Eijk developed ultra-precision CMM which was further commercialized as ISARA400 [16]. ISARA400 features include a volume measurement of 400×400×100 mm and a volumetric (3D) measurement uncertainty of 100 nm (2σ), ultra-precision CMM has been realized and is currently operational at IBS Precision Engineering. Huang et al [6] presented an innovative micro CMM with zero Abbe error that has been developed which includes some new design ideas, such as the self-made probe system, the metrological system and the co-planar stage. It has achieved the measuring uncertainty with 40 mm of about 100 nm (2δ).

The inventors wish to address at least some of the issues mentioned above.

### REFERENCES

[1] S. Hammad Mian and A. Al-Ahmari, “New developments in coordinate measuring machines for manufacturing industries,” International Journal of Metrology and Quality Engineering, vol. 5, no. 1, p. 101, 2014.
[2] G. Hermann, “Geometric Error Correction in Coordinate Measurement,” Acta Polytechnica Hungarica, vol. 4, no. 1, pp. 47-62, 2007.
[3] R. R. Nikam, “Coordinate measuring machine (CMM),” International Journal of Mechanical and Industrial Technology, vol. 6, no. 2, pp. 13-19, 2019.
[4] J. D. Claverley and R. K. Leach, “A review of the existing performance verification infrastructure for micro-CMM,” Precision Engineering, vol. 39, pp. 1-15, 2015.
[5] W. E. Singhose and W. P. Seering, “The Effect of Input Shaping on Coordinate Measuring Machine Repeatability,” in IFToMM World Congress on the Theory of Machines and Mechanisms, Massachusetts Institute of Technology, 1995.
[6] Q. Huang, K. Wu, C. Wang, R. Li, K. C. Fan and Y. Fei, “Development of an Abbe Error Free Micro Coordinate Measuring Machine,” Applied Science, vol. 6, no. 97, pp. 1-12, 2016.
[7] V. K. Seggelen, NanoCMM: a 3D Coordinate Measuring Machine with low moving mass for measuring small products in array with nanometer uncertainty, Eindhoven: Technishe University, 2007.
[8] P. Yang, T. Takamura, S. Takahashi, S. Takamasu, O. Sato, S. Osawa and T. Takatsuji, “Development of high-precision micro-coordinate measuring machine: Multi-probe measurement system for measuring yaw and straight motion error of XY linear stage,” elsevier, vol. 35, no. 3, pp. 424-430, 2011.
[9] J. A. Kramar, “Nanometre resolution metrology with the molecular measurement machine,” Measurement Science and Technology, vol. 16, no. 11, pp. 2121-2128, 2005.
[10] R. Thalmann, F. Meli and A. Kung, “State of the art of tactile micro coordinate metrology,” Applied Science, vol. 6, no. 150, pp. 1-13, 2016.
[11] S. Cao, U. Brand, T. Kleine-Besten, W. Hoffmann, H. Schwenke, S. Butefisch and S. Buttgenbach, “Recent developments in dimensional metrology for microsystem components,” Microsystem Technology, vol. 8, no. 1, pp. 3-6, 2002.
[12] E. C. Bos, F. M. Delbressine, H. Haitjema and K. Leuven, “High-accuracy CMM metrology for micro systems,” reasechgate, January 2004.
[13] K. C. Fan, Y. T. Fei, X. F. Yu, Y. J. Chen, W. L. Weng, F. Chen and Y. S. Liu, “Development of a low-cost micro-CMM for 3-D micro/nano measurements,” Measurement science and technology, vol. 17, no. 3, pp. 524-532, 2005.
[14] K.-C. Fan and W. Wang, “The Structure Design of a Micro-precision CMM with Abbé Principle,” ResearchGate, pp. 297-300, 2007.
[15] T. A. Ruijl and J. van Eijk, “A novel ultra precision CMM based on fundamental design principles,” in Proceedings of the ASPE topical meeting on Coordinate Measuring Machines, Delft, 2003.
[16] I. Widdershoven, R. Donker and H. A. Spaan, “Realization and calibration of the “Isara 400” ultra-precision CMM,” in 13th International Conference on Metrology and Properties of Engineering Surfaces, Eindhoven, Netherlands, 2011.
[17] S.-C. Toguem, A. Vissiere, M. Damak, C. Mehdi-Souzani, N. Anwer and H. Nouira, “Design of an ultra-high precision machine for form measurement,” CIRP Design, vol. 84, pp. 942-947, 2019.
[18] J. Brayn, “International Status of Thermal Error Research,” CIRP Annals, vol. 39, no. 2, pp. 645-656, 1990.

### SUMMARY OF THE INVENTION

In accordance with a first aspect of the invention there is provided a coordinate movement machine which includes:
a first member;
a displacement measuring sensor which is spaced from, and directed towards, the first member such that a functional line of the sensor is fixed on the first member;
a reflective member which is positioned in-between the sensor and the first member and whereby a reflective surface of the reflective member is angled perpendicular to the functional line of the sensor; and
a displacement arrangement which is configured to move/displace the reflective member relative to the first member and the sensor along three axes which define a global coordinate system, whereby the axes are angled perpendicular to one another,
wherein the sensor is angled such that its functional line, which is fixed on the first member, is angled at an oblique angle relative to all three the axes.

The term “coordinate movement machine” should be interpreted to refer to a machine which is configured to move a tool or measuring probe relative to an article within a three-dimensional space to either manufacture the article or measure the article. The term “coordinate movement machine” should therefore be interpreted to include a coordinate measuring machine (CMM), a 3D printer and a computer numerical control (CNC) machine.

The sensor may be angled such that its functional line, which is fixed on the first member, is angled at a substantially 45 degree angle relative to all three the axes.

The machine may include a support/platform on which an article/object can, in use, be located, and wherein the support/platform is fixed relative to the reflective member such that the displacement arrangement can move/displace the reflective member and the support/platform relative to the first member and the sensor along the three axes.

The reflective member may be a mirror.

The machine may be a coordinate measuring machine. The first member may be a measuring probe. The measuring probe may be a touch trigger probe. The functional line of the sensor may be directed towards a tip of the probe.

The machine may include a frame on which the probe and the sensor is mounted. The frame may be a cantilever frame which includes an operatively vertical member and an operatively horizontal member which extends away from the vertical member. The probe may be mounted to a free end of the horizontal member. The sensor may be mounted to a lower end of the vertical member.

The displacement arrangement includes a first displacement mechanism which is connected to the frame and which is configured to displace the frame, relative to the mirror and the support/platform, along a substantially vertical axis, whereby the vertical axis forms one of the three axes of the global coordinate system.

The displacement arrangement may include a second displacement mechanism which is connected to the support/platform and which is configured to displace the support/platform and the mirror, relative to the frame, within a substantially horizontal plane along two axes which extend perpendicular to each other along the plane, whereby the said two axes form the two other axes of the three axes of the global coordinate system.

The machine may include a measurement module which is configured to utilise information/data from the sensor in order to determine an indication of displacement of the first member relative to the sensor.

The measurement module may be configured to solve/implement a kinematic model in order to determine at least one geometric property of an article/object which is, in use, placed/provided on the support/platform.

The machine may include a controller which is configured to control the operation of the displacement arrangement. The controller may be configured to move the support/platform relative to the first member and the sensor along the three axes and to stop the movement when the first member contacts a surface of an article/object which is, in use, placed/provided on the support/platform. The measurement module may be configured to utilise information/data from the sensor whenever the first member stops after making contact with a surface of an article/object, in order to determine at least one geometric property of an article/object.

The machine may be a 3D printer. The first member may be a printing head.

The machine may be a computer numerical control (CNC) machine. The first member may be a machining tool.

### BRIEF DESCRIPTION OF THE DRAWINGS

The invention will now be described, by way of example, with reference to the accompanying diagrammatic drawings. In the drawings:

FIG. 1A shows a three-dimensional view of a coordinate measurement machine (CMM) in accordance with the invention;

FIG. 1B shows a side view of the CMM in FIG. 1A;

FIG. 1C shows another three-dimensional view of the CMM in FIG. 1A;

FIG. 1D shows a further three-dimensional view of the CMM in FIG. 1A;

FIG. 1E shows a schematic layout of the CMM in FIG. 1A;

FIG. 2 shows a kinematic diagram of the CMM shown in FIG. 1A;

FIG. 3 shows a metrology frame coordinate system in a Z axis;

FIG. 4 shows a manipulation coordinate system in an X-Y plane;

FIG. 5A shows a schematic illustration of an approach and retraction of a probe of the CMM, when measuring in an X-Y plane;

FIG. 5B shows a schematic illustration of an approach and retraction of a probe of the CMM, when measuring in a Z plane;

FIG. 6A shows a demonstration of the coordinate system of the mirror p-s in relations to the laser beam components

FIG. 6B shows a schematic side view of a portion of the CMM in accordance with the invention, which illustrates an optical triangle between the displacement sensor and the mirror of the CMM;

FIG. 6C shows a schematic view of a position of a laser pointer of the displacement sensor projected as dots on the mirror, as well as travel paths when the CMM is translated in various directions;

FIG. 6D shows a schematic view of a special triangle with two 45 degree angles;

FIG. 6E shows a schematic view of an optical triangle formed by the mirror and the displacement in X-Z plane;

FIG. 6F shows a schematic view of an optical triangle formed by the mirror and the displacement in X-Y plane;

FIG. 6G shows an illustration of an optical triangle formed by the relationship between a mirror and displacement sensor of the CMM in an X-Y plane of the CMM;

FIG. 6H shows a schematic illustration of out-of-squareness possibilities;

FIG. 6I shows a three-dimensional view of a position of the mirror of the CMM (typical p-s axis of the mirror and the deviation representatives);

FIG. 6J shows a graphical illustration of an average difference before and after calibration;

FIG. 6K shows a graphical illustration of random samples showing the approximates of the error deviation in the X axis;

FIG. 6L shows a graphical illustration of random samples showing the approximates of the error deviation in the Y axis;

FIG. 6M shows a graphical illustration of random samples showing the approximates of the error deviation in the Z axis;

FIG. 6N shows a histogram of the Monte Carlo Simulation results of the mirror out-of-squareness when the machine is translated in X axis;

FIG. 6O shows a histogram of the Monte Carlo Simulation results of the mirror out-of-squareness when the machine is translated in Y axis;

FIG. 6P shows a histogram of the Monte Carlo Simulation results of the mirror out-of-squareness when the machine is translated in Z axis;

FIG. 7 shows a photo of an experimental setup of the CMM with its controller/control system;

FIG. 8 illustrates a measuring procedure in the X axis;

FIG. 9 shows a graphical illustration of the data points of the samples taken during an experiment (in the X axis);

FIG. 10 illustrates a measuring procedure in the Y axis;

FIG. 11 shows a graphical illustration of the data points of the samples taken during an experiment (in the Y axis);

FIG. 12 illustrates a measuring procedure in the Z axis; and

FIG. 13 shows a graphical illustration of the data points of the samples taken during an experiment (in the Z axis).

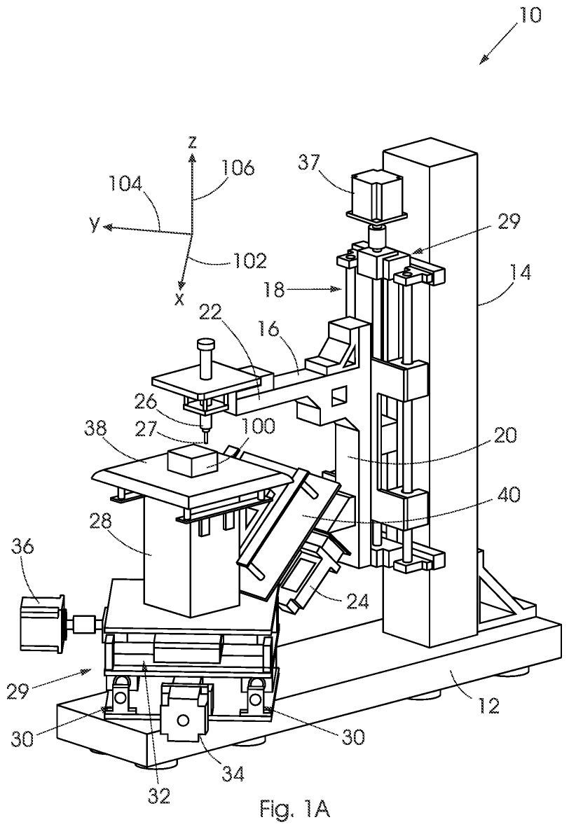

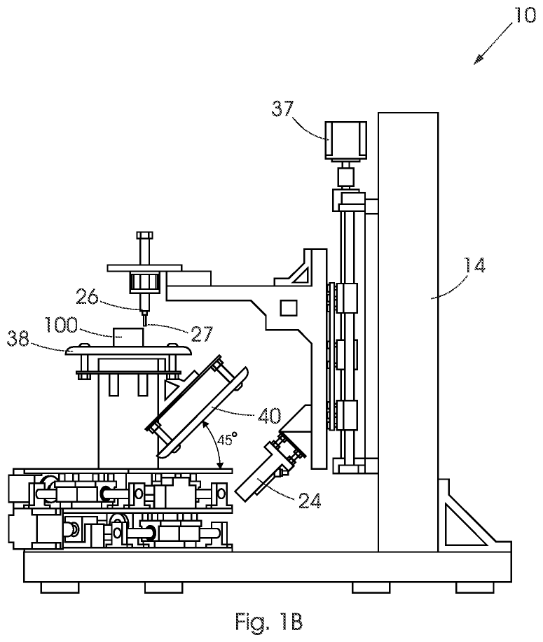

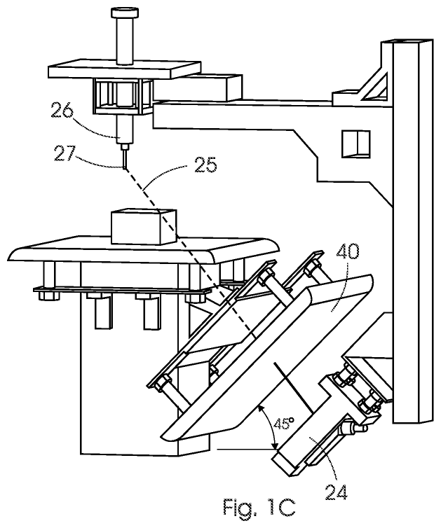

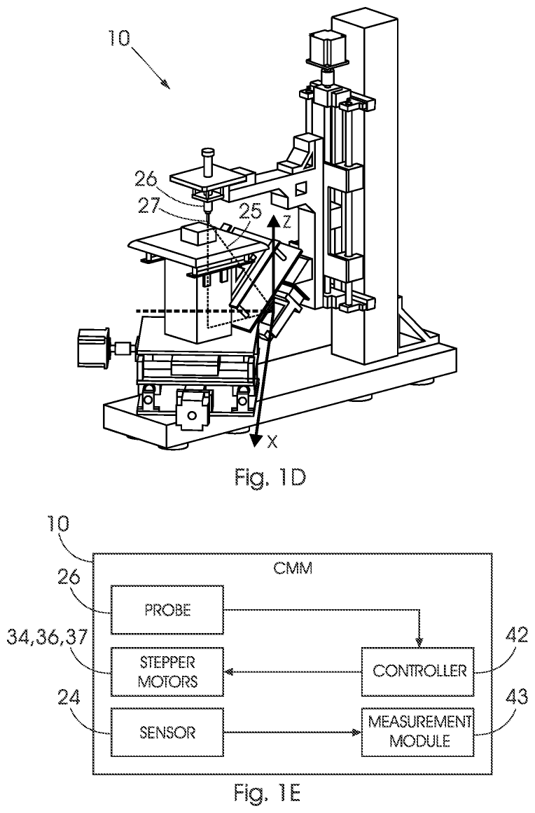

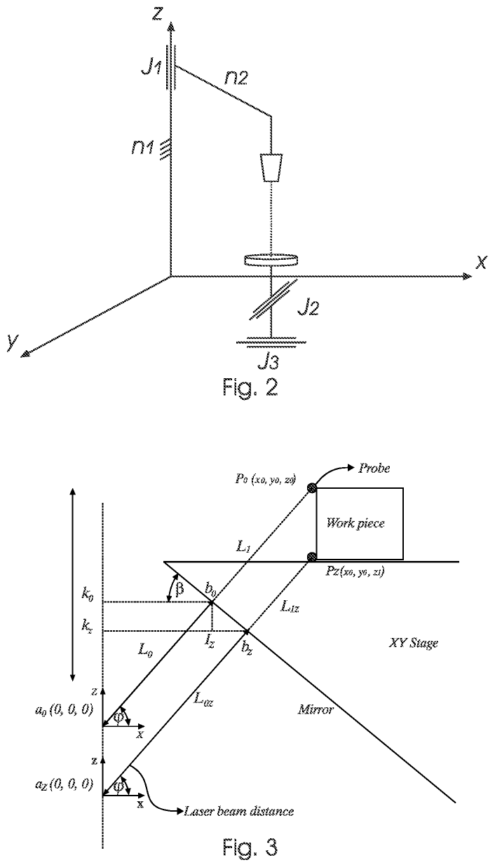

### DETAILED DESCRIPTION OF A PREFERRED EMBODIMENT

The present invention provides a coordinate movement machine which utilises only one displacement measuring sensor instead of three. Although the description hereinafter refers specifically to a coordinate measurement machine (CMM), it should be appreciated that the invention can also be adapted/applied to work for other types of coordinate movement machines, such as computer numerical control (CNC) machines and 3D printing machines. In these cases, the “first member 26” referred to further below would be in the form of a machining tool, a printing head or a manufacturing head.

Error! Reference source not found. A-E present the proposed CMM 10. The CMM 10 includes a base 12 and a vertically upright frame 14 which extends upwardly from, and is secured to, the base 12. A frame 16 (hereinafter referred to as the “metrology frame 16”) is displaceably/kinematically mounted on the upright frame 14 in order to allow the metrology frame 16 to be displaced relative to the upright frame 14 along a vertical axis. More specifically, the metrology frame 16 is mounted to the upright frame 14 via a prismatic joint 18, in order to allow the metrology frame 16 to slide along the vertical axis (hereinafter referred to as the Z-axis) relative to the upright frame 14. The metrology frame 16 is a cantilever frame which includes an elongate vertical member 20 and an elongate horizontal member 22 which extends away from a top portion of the vertical member 20.

A displacement measuring sensor 24 is mounted to a bottom end of the vertical member 20. A first member 26 is mounted to a free end of the horizontal member 22. The first member 26, in this example, is in the form of a touch trigger probe 26. Another type of probe could however also be used. Alternatively, the first member could be a manufacturing/assembling head for manufacturing/assembling a device/machine/product (or at least a part thereof). The probe 26 is directed vertically downwardly. The sensor 24 is spaced from, and directed towards, the probe 26, such that a functional line 25 of the sensor is fixed on a tip 27 of the probe 26. Therefore, as the metrology frame 16 slides upwardly and downwardly relative to the upright frame 14, the functional line of the sensor 24 remains fixed on the tip 27 of the probe 26.

A support arrangement 28 is mounted to the base 12 via a displacement arrangement 29. The displacement arrangement 29 includes two prismatic joints/joint arrangements 30, 32 in order to allow the support arrangement 28 to move/slide along an X-axis 102 and a Y-axis 104, respectively, whereby the X and Y axes are arranged perpendicular to one another and also perpendicular to the Z-axis 106, in order to form the three axes of a global coordinate measurement system. The displacement arrangement 29 includes a stepper motor 34 which is operatively connected to the one prismatic joint 30 in order to allow the support arrangement 28 to move/slide along the X-axis relative to the base 12 and the metrology frame 16. The displacement arrangement 29 includes another stepper motor 36 which is also operatively connected to the other prismatic joint 32 in order to allow the support arrangement 28 to move/slide along the Y-axis relative to the base 12 and the metrology frame 16.

The displacement arrangement 29 includes a further stepper motor 37 which is operatively connected to the prismatic joint 18, in order to allow the metrology frame 16 to slide along the Z-axis relative to the upright frame 14.

The support arrangement 28 includes a platform/table 38 on which an article/object 100 to be measured can be placed.

A reflective member in the form of a mirror 40 is mounted to the support arrangement 28. More specifically, the mirror 40 is arranged in-between the probe 26 and the sensor 24, with a reflective surface of the mirror facing the sensor 24. The mirror 40 is angled such that the reflective surface is perpendicular to the functional line 25 of the sensor 24 and angled at 45 degrees to the X, Y and Z axes. In other words, the reflective surface of the mirror is angled at 45 degrees relative to each plane of the global coordinate system. Due to the perpendicular angle of the reflective surface relative to the functional line 25 of the sensor 24, the sensor 24 is able to detect any change in distance between the sensor 24 and the mirror 40.

The CMM 10 includes a controller 42 to which the displacement arrangement 29 (more specifically the stepper motors 34, 36, 37) is operatively connected. The controller 42 is configured to control the operation of the motors 34, 36, 37. The CMM 10 also includes a measurement module 43 which is operatively connected to the sensor 24 and which is configured to utilise data/information received from the sensor 24 in order to determine, when the probe 26 is moved by the stepper motors 34, 36, 37 relative to an article 100 placed on the table 38, how far the probe 26 has been moved/displaced relative to the article 100 and in which direction. This aspect is described in more detail further below.

The mirror 40 is perpendicular and always intersects a laser beam (which projects along the functional line 25 of the sensor 24 in the direction of the tip 27) of the sensor 24 at a gap distance between the sensor 24 and the probe 26. The distance between the displacement sensor 24 and the mirror 40 changes with the change in the actuations of the joints 18, 30, 32. To archive small measuring uncertainty of the CMM 10, the present invention considers Abbe's principle as the fundamental basis of achieving high positioning accuracy [6], and also the separation of the metrology frame 14 and structural frame 16 of the CMM 10 [17]. The thermal distortion of the CMM as one of the main contributing error sources structures may be considered an important aspect of consideration as well.

### Degrees of Freedom

The mobility or the degrees of freedom of the CMM 10 can be calculated by using Grubler's formula, presented by Equation 1.

$$M = 6 ( n - j - 1 ) + {\sum }_{i = 1}^{J} {f}_{i} \qquad ( 1 )$$

Where M is the degrees of freedom, n is the number of bodies including the machine frame and the metrology systems, J is the number of joints, and fᵢ is the freedom of the iₜₕ joint. Error! Reference source not found. presents an open loop kinematic diagram of the machine with prisma.

The number of all bodies (links) is n=2. The number of joints, J=3, Prismatic joints with 1 DOF. Therefore, the degrees of freedom (DOF) of the machine M=3DOF.

### Coordinate System

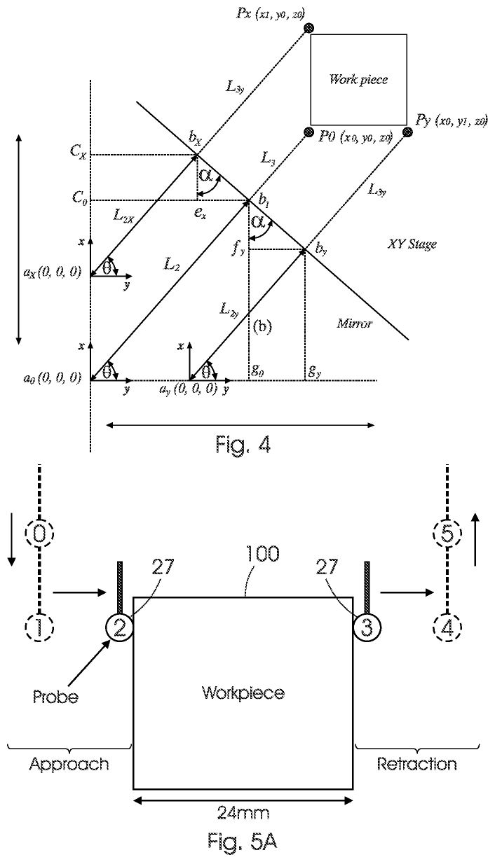

Fundamentally, the position of the probe 26 (i.e. the coordinates of the probe) is identified after every movement by solving a kinematic model knowing the direction of the translation, and the distance between the displacement sensor 24 and the mirror 40. More specifically, the controller controller 42 is configured, by way of software, to solve the kinematic model. The coordinates received are used in a computer programme/software module to calculate the size of the distance travelled by the probe 26 (e.g., size of the work piece). FIGS. 3 and 4 present the coordinate system of the module demonstrating the approach to measure a square block.

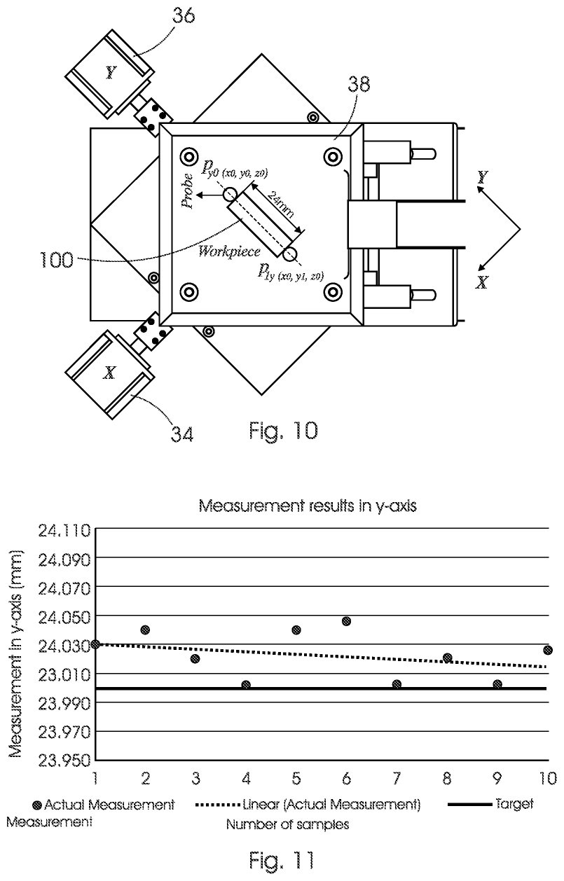

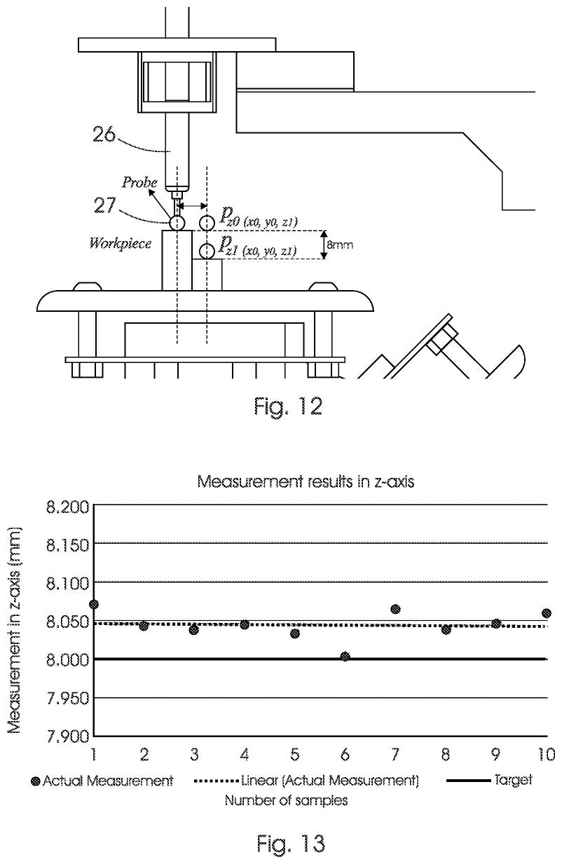

The origin of the coordinate system is placed where the measurement of the displacement sensor 24 is equal to zero, and is presented by a₀ (x₀, y₀, z₀). The translated original positions are presented by ax (xᵢ, y₀, z₀), a_{y}(x₀, yᵢ, z₀) and a_{z}(x₀, y₀, zᵢ) respectively. The initial probe position is demonstrated by P₀(x₀, y₀, z₀) and when translated to x, y and z is given as Pₓ(xᵢ, y₀, z₀), P_{y}(x₀, yᵢ, z₀) and P_{z}(x₀, y₀, zᵢ). L₀ is a laser beam measurement between the displacement sensor 24 and the mirror 40, and is presented by Lox, Loy and Loz when the machine is translated in x, y or z-axis. L₂, L₂ₓ, L_{2y} and L_{2z} are the hypotenuse components of the laser beam measurement when in zero position and translated. L₁, L₁ₓ, L_{1y} and L_{1z} are the extended distances at various translations of the laser beam from the mirror 40 to the probe 26, with the horizontal components of L₃, L₃ₓ, L_{3y} and L_{3z} when probing in different directions. The point of contact by the laser beam to the mirror 40 is presented by b₀, bₓ, b_{y} and b_{z} and the other points such as c₀, cₓ, g₀, gₓ, k₀, kₓ, eₓ, f_{y} and i_{z} are the points of intersection with respect to the specified vector (see FIG. 10). The probe angles and the position of the mirror 40 are set at 45° to all the sides of the coordinate system. The z-plane and x-y plane angles of the laser beam measurement and the mirror 40 are presented by φ and ⊕, and β and α respectively.

### a) Modelling of the Probe Position(s) in X-Axis

The position of the probe 26 and the distance between two positions in x-axis is formulated in reference to FIG. 4. The x-axis coordinates are described b_{y} position Pₓ(x₁, y₀, z₀), and the distance between two probe positions in X-axis is the distance. From the global coordinate system x₁ which is the initial position of the probe 26 can be formulated as:

x₁=x₀+Δx (2)

x₀=(L₂ₓ+L₃ₓ)sin θ (3)

Δx is the distance between P₀ and Pₓ, therefore, to find Δx; triangle [symbol] and the translated triangle [symbol] are employed to determine the distance b₁bₓ which is equal to the component A of P₀Pₓ.

$${b}_{1} {b}_{x} = \frac{{b}_{1} {e}_{x}}{sin α} \qquad ( 4 )$$

$${b}_{1} {b}_{x} = \frac{{b}_{1} {c}_{0} − {b}_{x} {c}_{x}}{sin α}$$

$${b}_{1} {b}_{x} = \frac{{L}_{2} cos θ − {L}_{2 x} cos θ}{sin α}$$

Therefore, P₀Pₓ (Δx) can be calculated as follow.

$${P}_{0} {P}_{x} = Δ x = \frac{{L}_{2} cos θ - {L}_{2 x} cos θ}{sin α \cdot cos θ} \qquad ( 5 )$$

$$Δ x = \frac{{L}_{2} - {L}_{2 x}}{sin α} \qquad ( 6 )$$

Therefore, Equation 2 can be expressed as follow:

$${x}_{1} = ( {L}_{2 x} + {L}_{3 x} ) sin θ + \frac{{L}_{2} - {L}_{2 x}}{sin α} \qquad ( 7 )$$

### b) Modelling of the Probe Position(s) in Y-Axis.

The position of the probe and the distance measurements in y-axis is formulated in reference to FIG. 4. The Y-axis coordinates is described by position Pₓ(x₀, y₁, z₀), and the d difference between two points in Y-axis will give the distance. From the global coordinate system y₁ can be formulated as:

y₁=y₀+Δy (8)

y₀=(L_{2y}+L_{3y})cos θ (9)

Δy is the distance between P₀ and P_{y}, therefore, to find Δy, triangle [symbol] and the translated triangle [symbol] are used to determine the distance b₁b_{y} which is equal to the component of P₀P_{y}.

$${b}_{1} {b}_{y} = \frac{{b}_{1} {f}_{y}}{cos α} \qquad ( 10 )$$

$${b}_{1} {b}_{y} = \frac{{b}_{1} {g}_{0} - {b}_{y} {g}_{y}}{cos α} \qquad ( 11 )$$

$${b}_{1} {b}_{y} = \frac{{L}_{2} sin θ - {L}_{2 y} sin θ}{cos α} \qquad ( 12 )$$

Since b₁b_{y} is equal to the component of P₀Pₓ therefore, Δy can be found as follow:

$${P}_{0} {P}_{y} = Δ y = \frac{{L}_{2} sin θ - {L}_{2 y} sin θ}{cos α \cdot sin θ} = \frac{{L}_{2} - {L}_{2 y}}{cos α} \qquad ( 13 )$$

$$Δ y = \frac{{L}_{2} - {L}_{2 y}}{cos α} \qquad ( 14 )$$

Therefore, Equation 8 can be expressed as follow:

$${y}_{1} = ( {L}_{2 y} + {L}_{3 y} ) cos θ + \frac{{L}_{2} - {L}_{2 y}}{cos α} \qquad ( 15 )$$

### c) Modelling of the Probe Position(s) in Z-Axis

The position of the probe and the distance between two positions in Z-axis is formulated in reference to FIG. 3. The z-axis coordinates are described b_{y} position P₁ (x₀, y₀, z₁), and the difference between two points suggest the distance. From the global coordinate system z₁ can be formulated as:

z₁=z₀+Δz (16)

z₀=(L₀+L₁)sin φ (17)

Δz is the distance between P₀ and P_{z}, therefore, to find Δz, triangle [symbol] and the translated triangle [symbol] are used to determine the distance b₀b_{z} which is equal to the component of P₀P_{z}.

$${b}_{0} {b}_{z} = \frac{{b}_{0} {i}_{z}}{sin β} \qquad ( 18 )$$

$${b}_{0} {b}_{z} = \frac{{b}_{0} {k}_{0} - {b}_{z} {k}_{z}}{sin β}$$

$${b}_{0} {b}_{z} = \frac{{L}_{0} cos φ - {L}_{0 z} cos φ}{sin β}$$

Since b₀b_{z} is equal to the component of P₀P_{z} therefore, Δz can be found as follow:

$${P}_{0} {P}_{z} = Δ z = \frac{{L}_{0} cos φ - {L}_{0 z} cos φ}{sin β \cdot cos φ} \qquad ( 19 )$$

$$Δ z = \frac{{L}_{0} - {L}_{0 z}}{sin β}$$

Therefore, Equation (16) can be expressed as Equation 20.

$${z}_{1} = ( {L}_{0} + {L}_{1} ) sin φ + \frac{{L}_{0} - {L}_{0 z}}{sin β} \qquad ( 20 )$$

The positioning Equations (7), (15) and (20) can be presented with respect to the laser beam measurements to Equation (21), (22), and (23).

$${x}_{1} = ( \frac{{L}_{0 x}}{sin φ} + ( ( {L}_{0 x} + {L}_{1 x} ) cos φ - \frac{{L}_{0 x}}{cos φ} ) ) sin θ + \frac{{L}_{0} - {L}_{0 x}}{sin α \cdot cos φ} \qquad ( 21 )$$

$${y}_{1} = ( \frac{{L}_{0 y}}{sin φ} + ( ( {L}_{0 y} + {L}_{1 y} ) cos φ - \frac{{L}_{0 y}}{cos φ} ) ) cos θ + \frac{{L}_{0} - {L}_{0 y}}{cos α \cdot cos φ} \qquad ( 22 )$$

$${z}_{1} = ( {L}_{0} + {L}_{1} ) sin φ + \frac{{L}_{0} - {L}_{0 z}}{sin β} \qquad ( 23 )$$

$$Δ x = \frac{{L}_{0} - {L}_{0 x}}{sin α \cdot cos φ} \qquad ( 24 )$$

$$Δ y = \frac{{L}_{0} - {L}_{0 y}}{sin α \cdot cos φ} \qquad ( 25 )$$

$$Δ z = \frac{{L}_{0} - {L}_{0 z}}{sin β} \qquad ( 26 )$$

Equation 23 and Equation 26 can only be employed if the probe positions to be measured are collinear e.g., positions 6 and 7 or 8 and 9 in FIG. 5B. In a case where the probe positions are not collinear, a reference position should be established using Equation 28. The probe diameter(S) is minused from Equation 24 and 25 when measuring workpiece displacement (4x and 4y) e.g. see FIG. 5A.

### Measurement Procedure

During the measurements, when the probe 26 contacts the workpiece 100, a signal is sent to the controller 42 (i.e. a computer control system) commanding the motor(s) 34, 36, 37 to stop. The position Pᵢ (xᵢ, yᵢ, zᵢ) in the space can be found by solving the forward kinematic modelling described above. Based on the developed model (implemented within the measurement module) the input parameters required for kinematic modelling include the distance between the displacement sensor 24 and the mirror 40, the position of angles of the mirror 40 and the sensor measurement and knowing the direction of the translation and the axis. The following steps summarize the steps of the measurement module 43 (and the controller 41 for moving the probe 26 relative to the workpiece 100) of the CMM 10:
1. Decide on the desired measurement of the workpiece 100.
2. Manipulate the system so that the probe 26 makes first contact at position P₀(x₀, y₀, z₀),
3. Record the distance L₀ between the displacement sensor 24 and the mirror 40.
4. Calculate the horizontal component if measuring on the x-y plane.
5. Move the probe 26 along the workpiece in the desired direction to touch the second point Pᵢ (xᵢ, yᵢ, zᵢ) and record laser measurement L₀ᵢ between the displacement sensor 24 and the mirror 40.
6. Use equations 21, 22 and 23 when calculating the position of the probe 26 and equations 24, 25 and 26 when calculating the distance of the workpiece.
7. Record the positions and the full dimension of the workpiece.

Error! Reference source not found, and Error! Reference source not found. present the path, the approach, and the retraction of the probe 26 from the workpiece 100 when measuring on X-, Y-, and Z-axis. The significance of the approach is considered at points 1-2, and 6-7 with a gap of 0.5 mm before touching the probe 26 at a reduced speed of 15 mm/s. The retraction of the probe 26 from the workpiece is presented by points 3-4 and 9-8. The black arrows present the direction of the probe 26 as it approaches and retract from the workpiece 100.

### Out of Squareness Calibration of the Mirror

Although the CMM 10 adheres to Abbe's principle in X, Y, and Z-axis, with unique key design considerations, obvious errors that need to be calibrated are observed. This is because the manufacturing process of the machine 10 would have caused a deviation from the ideal positioning. Thus the calibration of the mirror out-of-squareness was considered. The design assumes the displacement sensor 24 to be accurately positioned at 45° of the coordinate system (X, Y and Z axes), and the mirror 40 as an adjustable component for the calibrations. Error! Reference source not found. demonstrates the translation and the direction of the axis, the optical triangle of the laser beam, and the mirror axis.

As recommended by Ruijl and Eijk [15], the calibration procedure described herein was performed with standard machine tasks to prevent additional uncertainties that can be introduced due to the deformation of the table 38, while it is being attached to the displacement arrangement 29. Also, the displacement sensor 24 was used for the calibration measurements. The procedure displayed in Error! Reference source not found. assumes the out-of-squareness of the mirror 40 is due to the rotation of the mirror around the p axis and s axis.

Error! Reference source not found.B shows an ideal situation when the laser beam is assumed to be orthogonal to the mirror 40 forming a special trigonometric 45° triangle.

Error! Reference source not found. demonstrates the position of the laser pointer projected as dots 50 on the mirror and the travel paths when the CMM 10 is translated in various directions. In reference to Error! Reference source not found. Error! Reference source not found. summarizes the relationship between the laser pointer and machine translations.

TABLE 1
Relationship between machine translation and
the displacement vector of the laser pointer

| Machine | Displacement sensor |
|---|---|
| Translation | laser pointer |
| x +ve | aₚₛ eₚₛ |
| x −ve | aₚₛ cₚₛ |
| y +ve | aₚₛ bₚₛ |
| y −ve | aₚₛ dₚₛ |
| z +ve | aₚₛ fₚₛ |
| z −ve | aₚₛ gₚₛ |

Calibration with Special Triangle Technique

The calibration method is based on the fundamentals of trigonometric special triangles of 45° presented in Error! Reference source not found. This technique is suggested by the nature of the optical triangles formed by the mirror 40 and the laser beam of the displacement sensor 24 (see Error! Reference source not found).

The special triangle is defined as a triangle with two 45° angles and one 90° angle. It is an isosceles right-angle triangle, hence the length of the 2 sides is always equal. The consequence of having equal lengths is because of the two sides with equal angles. Since it is a right-angled triangle, Pythagoras' Theorem can be used to find the hypotenuse, so that the ratios of the length of sides is expressed as 1:1:\sqrt{2}.

### The Fundamentals of the Out-of-Squareness Calibration

Based on the fundamentals of the special angle and since the laser beam and the mirror 40 are theoretically orthogonal, the optical triangles can be expressed as the components of the special angle. Error! Reference source not found, and Error! Reference source not found. present the optical triangles with components, laser beam and the mirror 40. The change of either side due to machine translation suggests the new equal values on the equal sides of the triangle. Therefore, knowing the initial value of the laser beam measurement L₀ and the travel distance by laser pointers across the mirror Tₜᵢ, the value of the new laser beam measurement L₀ᵢ can be predicted. For the calibration the theoretical value can be compared with the measured value, and the difference in the two values suggests the out-of-squareness of the mirror.

### Prediction of the New Position

Error! Reference source not found. presents an ideal translation of the mirror 40 and the change of the laser distance component in X-Y plane. Where Tₘᵢ is the distance travelled by the machine/mirror in x, y or z directions respectively, Tₜᵢ is the difference between the displacement sensor measurement L₀ and new laser measurement L₀ᵢ.

Therefore, based on special triangle description discussed earlier, Equation 24 can be formed in reference to Error! Reference source not found. to estimate the new positioning distance in x and y directions.

$${L}_{new} = {L}_{initial} - {T}_{t} \qquad ( 27 )$$

$${T}_{t} = {T}_{m} \cdot cos ∅$$

$${L}_{2 i} = {L}_{2} - ( {T}_{m} \cdot cos ∅ )$$

$${L}_{2 i} = {L}_{2} - ( {T}_{m} \cdot cos 45 )$$

$${L}_{2 i} = ( \frac{{L}_{0}}{cos 45} - ( {T}_{m} \cdot cos 45 ) )$$

$${L}_{0 i} = ( \frac{{L}_{0}}{cos 45} - ( {T}_{m} \cdot cos 45 ) ) \times cos 45 \qquad ( 28 )$$

$${L}_{0 z} = ( {l}_{0} - ( {T}_{m} \cdot cos 45 ) ) \qquad ( 29 )$$

Equation 25 and 26 can be used to estimate the new value of the measurement between the laser beam and the mirror.

### Out of Squareness Error Modelling

Error! Reference source not found. demonstrates the possibilities of out-of-squareness, here the mirror deviates from the theoretical position b₁ b′₀. The error possibilities can either be an acute angle b₁b₊ᵢ or at an obtuse angle b₁b₋ᵢ. Due to out-of-squareness of the mirror the translation distance from position b₀ change to b₀b₊ᵢ or b₀b₋ᵢ.

Therefore, the difference between the theoretical position aᵢb′₀ and aᵢb₋ᵢ or aᵢb₊ᵢ suggest out-of-squareness of the mirror which can be presented by the error angles e₋ᵢ and e₊ᵢ respectively.

b₋ᵢb′₀ᵢ=aᵢb′₀−aᵢb₋ᵢ (30)

b′₀b₊ᵢ=aᵢb′₀+aᵢb₋ᵢ (31)

Where aᵢb′₀, is the ideal hypotenuse component of the imaginary laser distance L₀ᵢ and aᵢb₋ᵢ and aᵢb₊ᵢ are the measured hypotenuse component values. Therefore, assuming the laser beam is at 45° for both theoretical and for actual calculations, Equation 30 and Equation 31 can be expanded as follows.

$${b}_{- i} {b}_{0}^{′} = ( \frac{{L}_{0}}{cos φ} + {T}_{m} cos α ) - \frac{{L}_{0 i}}{cos φ}$$

$${b}_{0}^{′} {b}_{+ i} = ( \frac{{L}_{0}}{cos φ} - {T}_{m} cos α ) + \frac{{L}_{0 i}}{cos φ}$$

The error angle of the mirror e₋ᵢ and e₊ᵢ can be calculated as follows:

$${e}_{- i} = {tan}^{- 1} ( \frac{{b}_{- i} {b}_{0}^{′}}{{T}_{m} \times cos α} )$$

$${e}_{- i} = {tan}^{- 1} ( \frac{( \frac{{L}_{0}}{cos φ} + {T}_{m} cos α ) - \frac{{L}_{0 i}}{cos φ}}{{T}_{m} \times cos α} )$$

$${e}_{+ i} = {tan}^{- 1} ( \frac{{b}_{+ i} {b}_{0}^{′}}{{T}_{m} \times cos α} )$$

$${e}_{+ i} = {tan}^{- 1} ( \frac{( \frac{{L}_{0}}{cos φ} + {T}_{m} cos α ) + \frac{{L}_{0 i}}{cos φ}}{{T}_{m} \times cos α} )$$

The formula for the error angles can be summarised as follows depending on the machine translation, where eₓ, e_{y} and e_{z} are the respective error angles when the machine is translated in the X, Y, or Z-axis.

$${e}_{x} = {tan}^{- 1} ( \frac{{L}_{0}}{{T}_{mx} \times cos α \times cos φ} \pm 1 \pm \frac{{L}_{{0}_{x}}}{{T}_{mx} \times cos α \times cos φ} ) \qquad ( 32 )$$

$${e}_{y} = {tan}^{- 1} ( \frac{{L}_{0}}{{T}_{my} \times cos α \times cos φ} \pm 1 \pm \frac{{L}_{{0}_{y}}}{{T}_{my} \times cos α \times cos φ} ) \qquad ( 33 )$$

$${e}_{z} = {tan}^{- 1} ( \frac{{L}_{0}}{{T}_{mz} \times cos β} \pm 1 - \frac{{L}_{{0}_{z}}}{{T}_{mz} \times cos β} ) \qquad ( 34 )$$

### Calibration Procedure

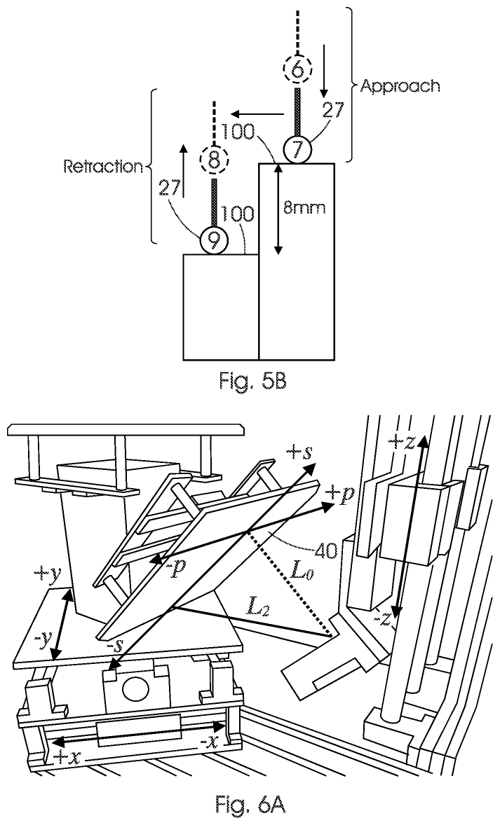

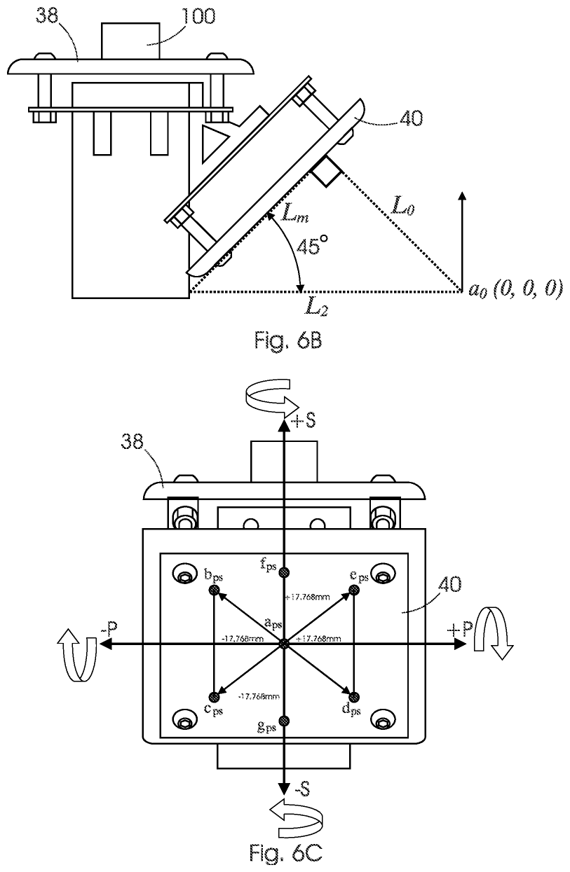

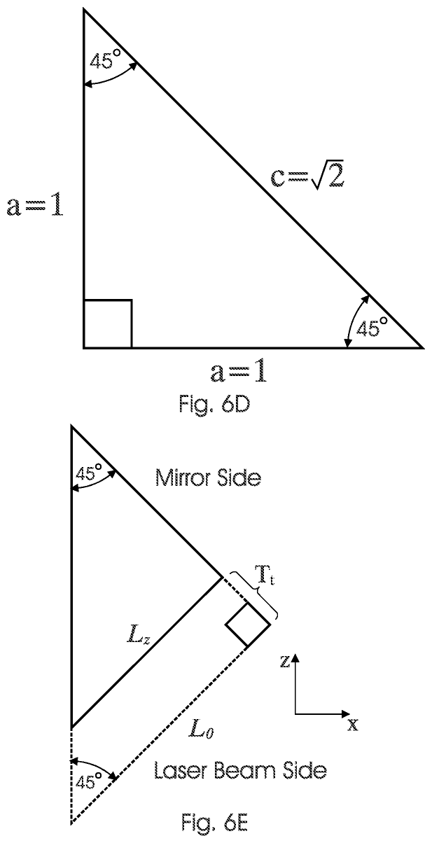

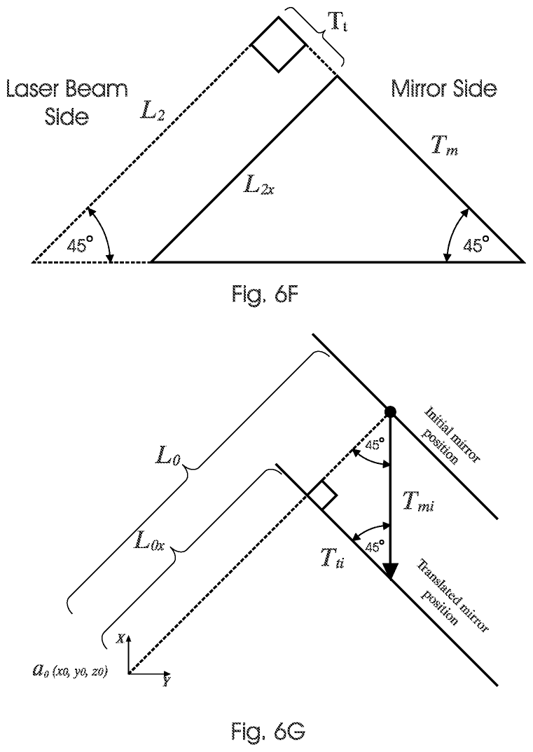

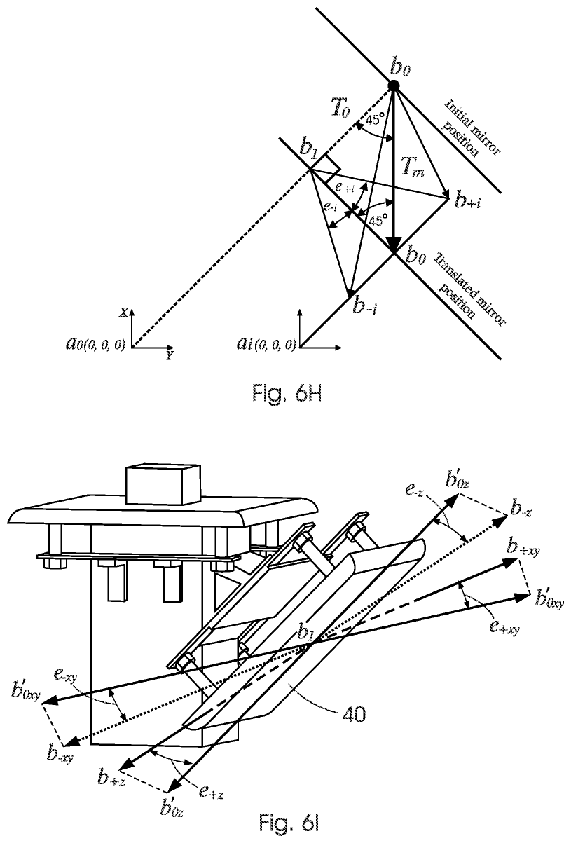

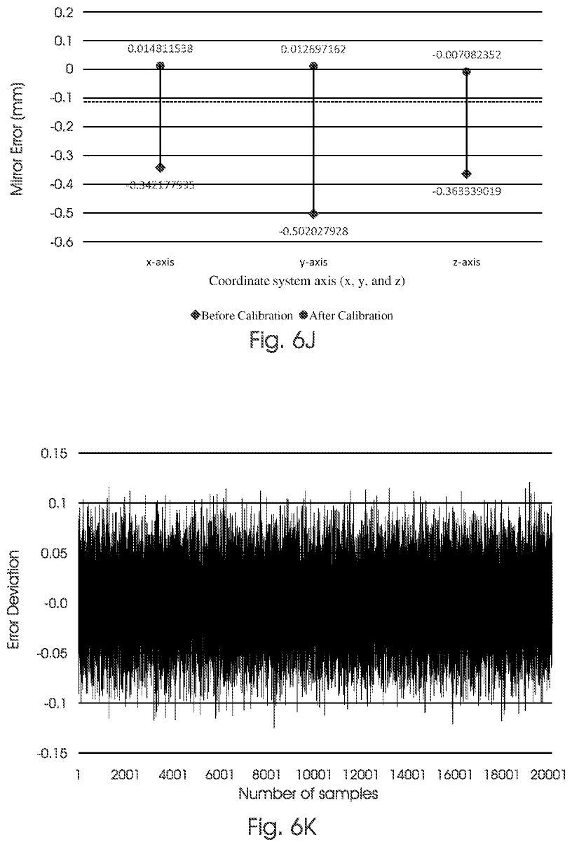

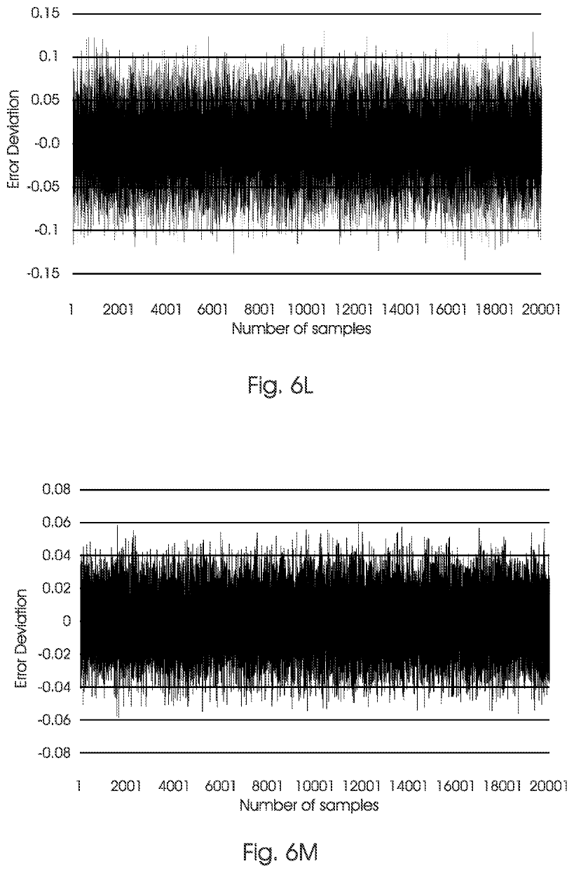

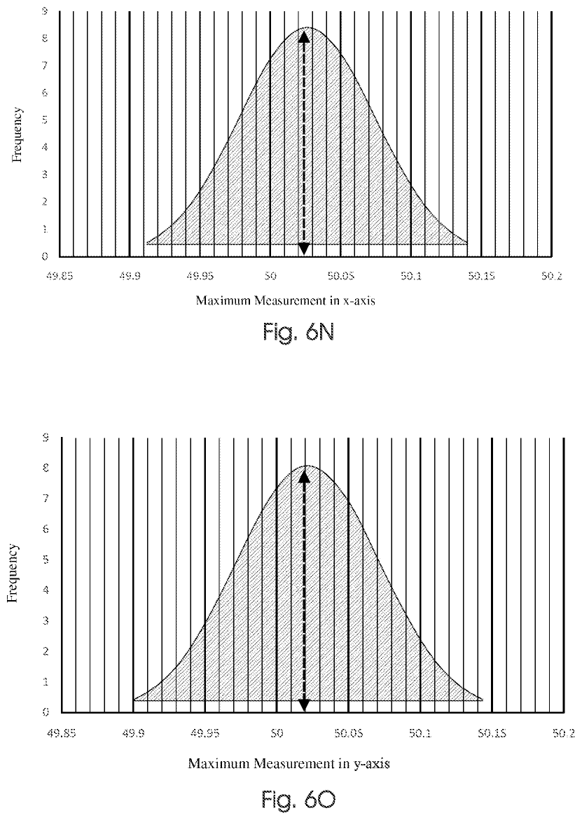

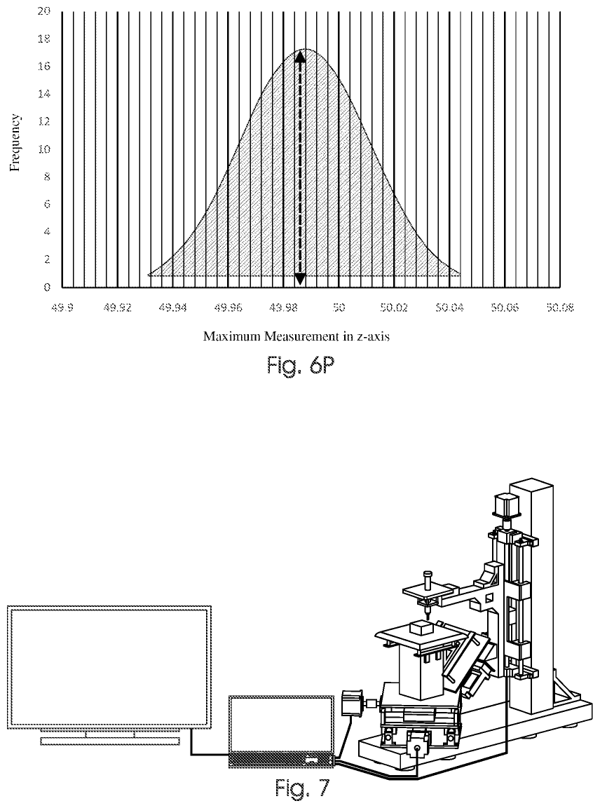

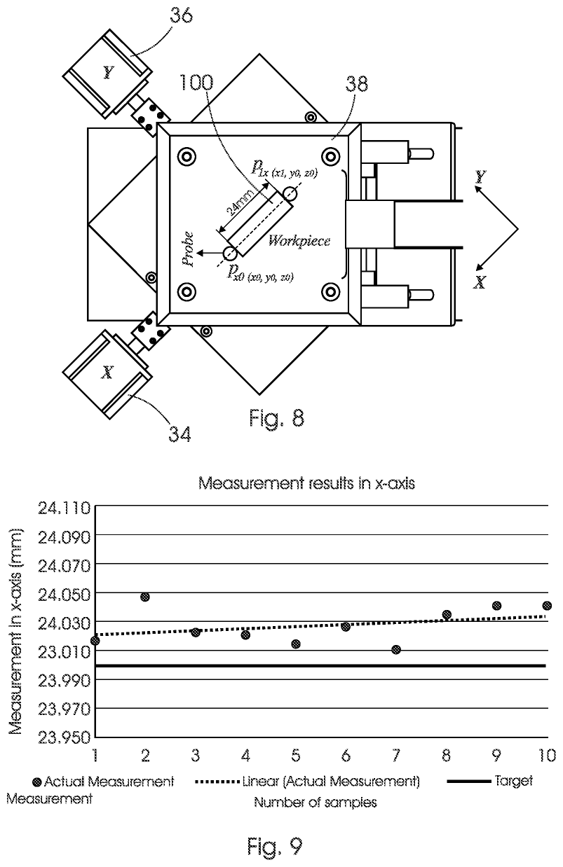

The calibration is performed in all directions of measurements. Assuming FIG. 6H presents the movement of the machine during the calibration method.
1. Position the probe 26 at position P₀(x₀, y₀, z₀) and record L₀.
2. During the calibration in the x-y plane calculate L₂ (the hypotenuse of L₀).
3. Determine the translation distance of each axis.
4. Predetermine the new laser beam distance using Equation 25 for x and y-axis, and Equation 26 for the z-axis.
5. Move the machine to the desired position based on the defined travel distance.
6. Compare the predetermined positioning distance and the actual reading.
7. If not comparable adjust the mirror 40 and repeat the process.

### Out of Squareness Calibration

During the calibration, the machine axis was set to travel a maximum distance of 50 mm in either direction (positive or negative translation of each axis). The calibration procedure was employed to predict the calculated laser beam measurement (Localculated) and compared it with the measured laser beam measurement (Lomeasurement) with the machine. The translation on each axis direction was repeated 14 times to verify the repeatability. Error! Reference source not found. presents the as-found position of the mirror.

Random samples approximate to 20 000 were generated in Excel to calculate the average and the standard deviation of the errors before and after the calibration (see Table and Table). Error! Reference source not found. presents the average error of the mirror (ei) in X, Y and Z axis.

TABLE 2
The results of the mirror position before the calibration

| | Standard | |
|---|---|---|
| Translation | Deviation | Average |
| Axis | (mm) | (mm) |
| x | 0.232 | −0.348 |
| y | 0.232 | −0.507 |
| z | 0.021 | −0.363 |

TABLE 3
The results of the mirror position after the calibration

| | Standard | |
|---|---|---|
| Translation | Deviation | Average |
| Axis | (mm) | (mm) |
| x | 0.027 | 0.015 |
| y | 0.028 | 0.012 |
| z | 0.013 | 0.007 |

Error! Reference source not found.provides a representation of the random samples showing the approximates of the error deviation.

Out of Squareness Uncertainty with Monte Carlo Simulation

The Monte Carlo simulation as a preferred method was applied to compute the measuring uncertainty due to out-of-squareness of the mirror. 20 000 random parameter values were generated from ten-time samples taken. The simulation produces results in the form of standard deviation. This standard uncertainty is defined for each axis of the machine and that of the mirror.

During the simulation the number of trials (M) were determined using GUM Supplement 1 recommendations by following the general rule (see Equation 28), to provide a reasonable representation of the expected result:

$$M > \frac{{10}^{4}}{1 - p} \qquad ( 35 )$$

Where 50p % is the selected coverage probability. So, for example, when the chosen coverage probability is 50%, p=0.50 and M should be at least higher than 20,000. In each runM, (M=1, . . . , N), a random error value is generated. Microsoft Excel was used to generate random variables, running the Monte Carlo simulation with M=20 000 trials. Equations 24, 25, and 26 were employed to model the out-of-squareness uncertainty of the measurement mirror. These functions, depends on random variables (Lₓ_{₀}, Lₓ_{₁}, L_{y}_{₀}, L_{y}_{₁}, L_{z}_{₀}, L_{z}_{₁}, β, α) and (φ) remain a constant. The probability density function that best represents the random variables presented in this study is a Gaussian distribution (see Equation 36). Each distribution has u as mean value and o standard deviation. Table 4 presents the mean and the standard deviation of each variable.

TABLE 4
Mean and the standard deviation of the input variables

| Inputs | Mean (μ) | Std (σ) |
|---|---|---|
| Variables | (mm) | (mm) |
| L0x | 91.385 | 0.010 |
| L1x | 66.385 | 0.007 |
| αx | 44.973 | 0.027 |
| L0y | 74.726 | 0.004 |
| L1y | 49.738 | 0.003 |
| αy | 44.993 | 0.028 |
| L0z | 96.547 | 0.005 |
| L1z | 61.174 | 0.004 |
| βy | 45.003 | 0.0133 |

$${g}_{x} ( τ ) = ( \frac{1}{\sqrt{2 π} \times u ( x )} {e}^{( - \frac{{( τ - x )}^{2}}{2 {u}^{2} ( x )} )} ) \qquad ( 36 )$$

### Measurement Uncertainty Results

Error! Reference source not found. to Error! Reference source not found.P show the histogram of the Monte Carlo Simulation results. Table 0 to Table 2 contain the statistical parameters corresponding to the histogram.

TABLE 0
Statistical parameters in x-axis

| Parameter (x-axis) | Value (mm) |
|---|---|
| Mean | 50.026 |
| Standard deviation | 0.048 |
| Low endpoint | 49.913 |
| High endpoint | 50.140 |

TABLE 1
Statistical parameters in y-axis.

| Parameter (y-axis) | Value (mm) |
|---|---|
| Mean | 50.022 |
| Standard deviation | 0.050 |
| Low endpoint | 49.902 |
| High endpoint | 50.143 |

TABLE 2
Statistical parameters in z-axis

| Parameter (z axis) | Value (mm) |
|---|---|
| Mean | 49.988 |
| Standard deviation | 0.023 |
| Low endpoint | 49.932 |
| High endpoint | 50.044 |

### Gauge Block Measurement

The CMM was calibrated with a 24 mm calibration/gauge block from Matrix-Pitter with Grade 1 for x and γ-axis measurements, and an 8 mm step was measured in Z-axis. The machine used a TP20 touch-trigger probe 20 mm long with a 3 mm diameter ball (the probe diameter is demonstrated by(S). The kinematic model was employed to compute the measurements. The measurements were repeated ten times to validate the repeatability, and the GRBL was used to control the machine in either direction, set the step size, the design is 1 mm (step size) in equal to 2.5 mm (machine displacement), and the feed rate was adjusted to suit the requirements. Error! Reference source not found. shows the experimental set-up of the CMM and its control system.

### Measurements in X-Axis

Error! Reference source not found. presents the measuring procedure in the x-axis showing the points of contact on the workpiece presented by Pₓ₀ (x₀, y₀, z₀) and Pₓ₁ (x₁, y₀, z₀) respectively. Equation 21 is employed respectively to calculate the probe position (Pₓ₀ and Pₓ₁), and Δx size of the workpiece on the X-axis. Error! Reference source not found. presents the data points of the samples taken during the experiment.

### Measuring in the Y-Axis

Error! Reference source not found. presents the measuring procedure in the y-axis showing the points of contact on the workpiece presented by P_{y0} (x₀, y₀, z₀) and P_{y1} (x₀, y₁, z₀) respectively. Equation 22 is employed respectively to calculate the probe position (P_{y0} and P_{y1}), and Δy size of the workpiece on the Y-axis. Error! Reference source not found.Error! Reference source not found. presents the data points of the samples taken during the experiment.

### Measuring in the Z-Axis

Error! Reference source not found.2 presents the measuring procedure in the Z-axis showing the points of contact on the workpiece presented by P_{z0} (x₀, y₀, z₀) and P_{z1} (x₀, y₀, z₁) respectively. Equation 23 is employed respectively to calculate the probe position (P_{z0} and P_{z1}), and Δz size of the workpiece on the Z-axis. Error! Reference source not found.3Error! Reference source not found. presents the data points of the samples taken during the experiment.

It will be appreciated that all the calculations mentioned above in relation to the kinematic model described in the specification is typically implemented by the measurement module 43 (in software). The controller 42 is in turn configured to perform all the relative displacements by operating the motors 34, 36, 37. In one embodiment, the controller 42 and the measurement module 43 may be different units, while in another embodiment they may be implemented within the same unit/device/arrangement.

From the above, it should be apparent that the CMM 10 in accordance with the invention provides a solution to the accuracy demand and precision requirements brought on by the current rapid development of Micro Electromechanical Systems (MEMs). The cost for producing the CMM 10 is reduced significantly by reducing the number of measuring displacement sensors from three to one, whilst complying with the Abbé principle. Abbé's principle is essentially complied with due to the fact that the displacement sensor is placed in a position at an angle of 45° to each plane surface (x-y, x-z, and γ-z) and points directly towards the probe's tip with a fixed distance. Once the probe comes into contact with the work piece, its coordinates are identified by solving the kinematic model, (both forward kinematics and inverse kinematics). As will be clear from the earlier description, the kinematic model (implemented by the measurement module 43) is implemented to define the distance between two points knowing the direction of movement and the reading from the displacement sensor. The CMM 10 was further validated by the simulation on a 24 mm calibration/gauge block from Matrix-Pitter with Grade 1 for x and γ-axis measurements, and an 8 mm step was measured in z-axis. The results obtained indicated a measurement uncertainty of 12μ, 16μ and 18μ in x, y and z directions.

1. A coordinate movement machine which includes:
a first member;
a displacement measuring sensor which is spaced from, and directed towards, the first member such that a functional line of the sensor is fixed on the first member;
a reflective member which is positioned in-between the sensor and the first member and whereby a reflective surface of the reflective member is angled perpendicular to the functional line of the sensor; and
a displacement arrangement which is configured to move/displace the reflective member relative to the first member and the sensor along three axes which define a global coordinate system, whereby the axes are angled perpendicular to one another,
wherein the sensor is angled such that its functional line, which is fixed on the first member, is angled at an oblique angle relative to all three the axes.

2. The machine as claimed in claim 1, wherein the sensor is angled such that its functional line, which is fixed on the first member, is angled at a substantially 45 degree angle relative to all three the axes.

3. The machine as claimed in claim 2, wherein the machine includes a support/platform on which an article/object can, in use, be located, and wherein the support/platform is fixed relative to the reflective member such that the displacement arrangement can move/displace the reflective member and the support/platform relative to the first member and the sensor along the three axes.

4. The machine as claimed in claim 3, wherein the reflective member is a mirror.

5. The machine as claimed in claim 4, wherein the machine is a coordinate measuring machine.

6. The machine as claimed in claim 5, wherein the first member is a measuring probe.

7. The machine as claimed in claim 6, wherein the measuring probe is a touch trigger probe, and wherein the functional line of the sensor is directed towards a tip of the probe.

8. The machine as claimed in claim 7, which includes a frame on which the probe and the sensor is mounted.

9. The machine as claimed in claim 8, wherein the frame is a cantilever frame which includes an operatively vertical member and an operatively horizontal member which extends away from the vertical member, wherein the probe is mounted to a free end of the horizontal member and the sensor is mounted to a lower end of the vertical member.

10. The machine as claimed in claim 8, wherein the displacement arrangement includes a first displacement mechanism which is connected to the frame and which is configured to displace the frame, relative to the mirror and the support/platform, along a substantially vertical axis, whereby the vertical axis forms one of the three axes of the global coordinate system.

11. The machine as claimed in claim 10, wherein the displacement arrangement includes a second displacement mechanism which is connected to the support/platform and which is configured to displace the support/platform and the mirror, relative to the frame, within a substantially horizontal plane along two axes which extend perpendicular to each other along the plane, whereby the said two axes form the two other axes of the three axes of the global coordinate system.

12. The machine as claimed in claim 3, which includes a measurement module which is configured to utilise information/data from the sensor in order to determine an indication of displacement of the first member relative to the sensor.

13. The machine as claimed in claim 12, wherein the measurement module is configured to solve/implement a kinematic model in order to determine at least one geometric property of an article/object which is, in use, placed/provided on the support/platform.

14. The machine as claimed in claim 13, which includes a controller which is configured to control the operation of the displacement arrangement, wherein the controller is configured to move the support/platform relative to the first member and the sensor along the three axes and to stop the movement when the first member contacts a surface of an article/object which is, in use, placed/provided on the support/platform, and wherein the measurement module is configured to utilise information/data from the sensor whenever the first member stops after making contact with a surface of an article/object, in order to determine at least one geometric property of an article/object.
